(19) United States
(12) Patent Application Publication
(10) Pub. No.: US 2004/0260423 A1
(43) Pub. Date: Dec. 23, 2004

(54) Article storage and retrieval arrangement and method

(76) Inventors: Sung-Yeol Lee, Cheonan-city (KR); Young-Kyun Sun, Cheonan-city (KR); Sang-Hoon Lee, Cheonan-city (KR); No-Shin Park, Cheonan-city (KR); Jae-Nam Lee, Cheonan-city (KR)

Correspondence Address: HARNESS, DICKEY & PIERCE, P.L.C., P.O. BOX 8910, RESTON, VA, 20195, US

(21) Appl. No.: 10/769,883

(22) Filed: Feb. 3, 2004

(30) Foreign Application Priority Data
Jun. 20, 2003 (KR) 2003-0040170

(51) Int. Cl. G06F 7/00

(52) U.S. Cl. 700/214

(57) ABSTRACT

The arrangement and method determine if an article requested in a retrieval request is destined for storage and retrieve the article prior to storage when it is determined that the article requested in a retrieval request is destined for storage.

### CROSS REFERENCE TO RELATED APPLICATIONS

This U.S. non-provisional application claims priority under 35 U.S.C. §119 to Korean Patent Application No. 2003-40170 filed Jun. 20, 2003, the entire contents of which are incorporated by reference.

### BACKGROUND OF THE INVENTION

1. Field of the Invention

The exemplary embodiments of the present invention relate to an article storage and retrieval arrangement and method.

2. Description of the Related Art

Article storage and retrieval systems have been developed for permitting storage and retrieval of articles. Such systems may employ a computer for more efficient performance, as the quantity and frequency of articles increases.

A conventional article storage and retrieval system puts articles in the storage area, and retrieves the stored articles from the storage area when the articles are requested. Once articles are in storage, the articles can be retrieved from storage. When a request is generated for articles before they are in storage, prompt retrieval is not possible. Thus, the conventional article storage and retrieval system has inefficiency problems affecting access time and/or storage space.

### SUMMARY OF THE INVENTION

Exemplary embodiments of the present invention are directed to an article storage and retrieval arrangement.

In at least one exemplary embodiment of the article storage and retrieval arrangement, the arrangement determines if an article requested in a retrieval request is destined for storage. If so, then the arrangement retrieves the article prior to storage.

In at least one exemplary embodiment of the article storage and retrieval arrangement a storage conveyor is configured to convey articles to a storage area and an article identification unit is configured to identify articles on the storage conveyor. A management server may also be present to manage retrieval and storage of the articles based on the article identification and received retrieval requests. For example, in one exemplary embodiment, the management server may compare article information of an identified article to retrieval request article information before the identified articles are stored to determine if an article destined for storage should be retrieved.

### BRIEF DESCRIPTION OF THE DRAWINGS

Exemplary embodiments of the present invention will be readily understood with reference to the following detailed description thereof provided in conjunction with the accompanying drawings, wherein like reference numerals designate like structural elements, and in which:

FIG. 1 is a schematic view of an article storage and retrieval arrangement in accordance with an exemplary embodiment of the present invention; and

FIG. 2 is a flow chart of an article storage and retrieval arrangement in accordance with an exemplary embodiment of the present invention.

### DETAILED DESCRIPTION OF THE INVENTION

Exemplary embodiments of the present invention will be described below with reference to the accompanying drawings.

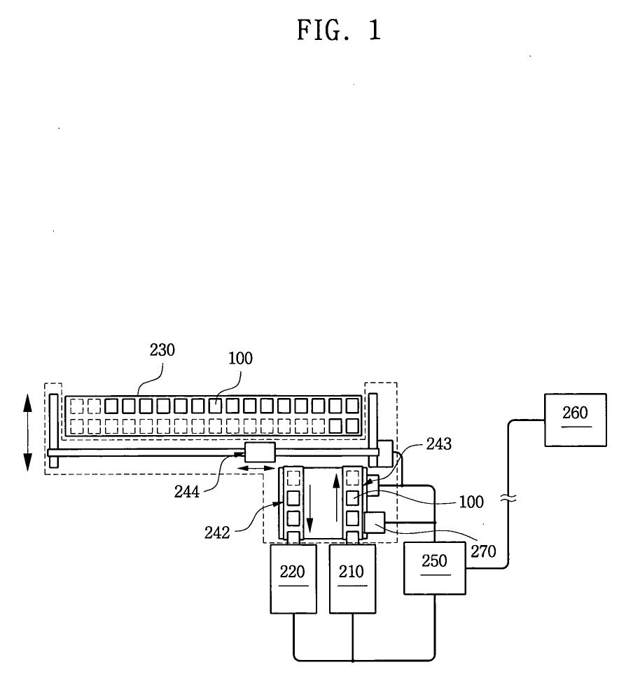

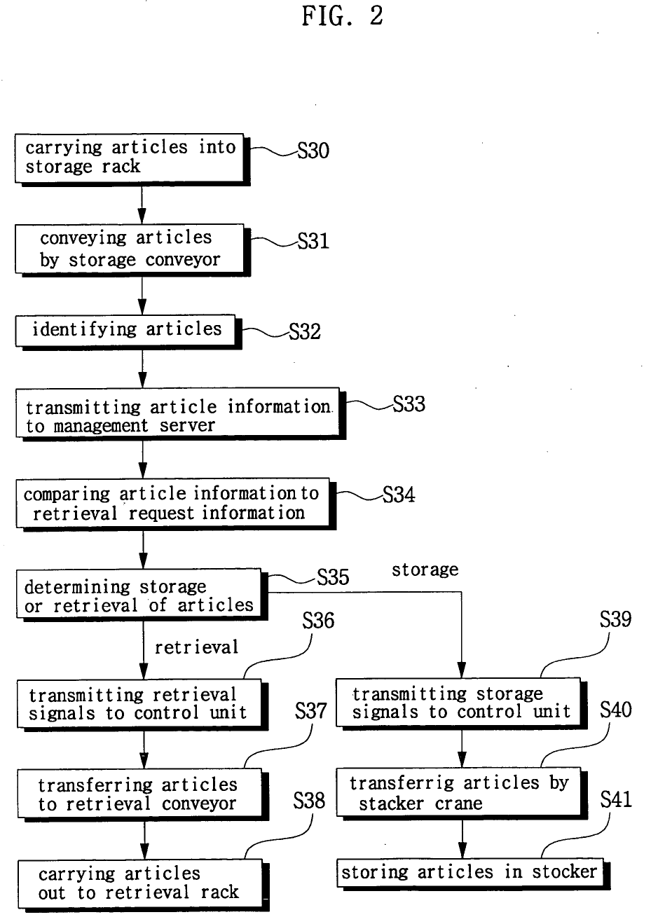

FIG. 1 illustrates an exemplary embodiment of an article storage and retrieval arrangement according to the present invention. FIG. 2 illustrates a flowchart of the method for article retrieval and storage according to an embodiment of the present invention. As shown in FIGS. 1 and 2, articles 100 are carried into a storage rack 210 in step S30. A storage conveyor 243 then conveys the articles from the storage rack 210 to a stocker 230 in step S31. At this time, the articles 100 are identified by an article identification unit 270 in step S32. In one exemplary embodiment, the identification unit 270 is a bar code scanner. However, other article identification technology may be employed and the scope of this exemplary embodiment should not be limited to a bar code scanner. A control unit 250 receives the identification information from the control unit 250 and sends the article identification information to a management server 260 in step S33.

In one exemplary embodiment, the management server 260 stores article information for each article being placed into storage. The article information includes article identification information such as the bar code of the article, and article attribute information. For example, the article attribute information for the articles being placed into storage are stored as a look-up table indexed by the respective article identification information. The attribute information includes, for example, the specifications of the article. For instance, if the article is a computer, the attribute information may include make and model number. The attribute information may also include more detailed information such as processor type and speed, drives and ports of the computer, etc. A computer has been identified as one possible article for storage, but it will be understood that the articles being stored are not limited to computers.

The management server 260 may receive the article information by user input directly, or via electronic transfer such as over an intranet or internet connection. The management server 260 also receives retrieval requests that request retrieval of an article. A retrieval request may provide article identification information only, article attribute information only, or both.

When the management server 260 receives the article identification information from the control unit 250, the management server 260 accesses the attribute information associated with the identified article from, for example, the look-up table. This article information is then compared to the article information in the queue of retrieval requests in step S34. For example, if a retrieval request provides article identification information, the retrieval request article identification information is compared with the article identification information received from the control unit 250. Alternatively, if the retrieval request includes only article attribute information, the management server 260 compares the retrieval request attribute information with the article attribute information associated with the article identification information received from the control unit 250. If a match is not found during these comparisons, then the management server 260 determines in step S35 to store the identified article.

Accordingly, the management server 260 sends storage signals to the control unit 250 instructing storage of the identified article in step S39. In response, the control unit 250 controls a stacker crane 244 in step S40 to transfer the article from the storage conveyor 243 and store the article in the stocker 230 in step S41.

If a match is found during the comparisons of step S34, then the management server 260 determines in step S35 to retrieve the article from the storage conveyor 243 in step S35. Accordingly, in step S36, the management server 260 sends retrieval signals to the control unit 250 instructing retrieval of the identified article. In response, the control unit 250 controls the stacker crane 244 in step S37 to transfer the article from the storage conveyor 243 and to a retrieval conveyor 242. Then the retrieval conveyor 242 conveys the articles to a retrieval rack 220 in step S38.

The storage conveyor 243 and the retrieval conveyor 242 may be of various types. As non-limiting examples, a belt type, a chain type or a roller type may be provided. In one exemplary embodiment, a storage conveyor 243 is a roller type conveyor mechanically connected to the retrieval conveyor 242. However, a belt type or a chain type may be used under various conditions.

A series of overall operations may also be performed by system operating software, for example, an auto dispatching system (ADS), a carrier buffer system (CBS) and an equipment control system (ECS). An article transfer unit, such as the conveyors 242, 243 and the stacker crane 244, as non-limiting examples, may be varied in their type and configuration according to the structure of a system. For example, a forklift or other stacking device may be used. Likewise, other conveying devices may be similarly used.

An arrangement for article storage and retrieval in accordance with at least one embodiment of the present invention compares at least one of article identification information and article attribute information with retrieval request information before storage. These exemplary embodiments may lead to a prompt retrieval when articles 100 are carried in on the storage conveyor 243. Thereby storage time and space usage may be reduced, the mechanism of the article transfer unit may be simplified and thus operation efficiency may be improved.

Although the exemplary embodiments of the present invention have been described in detail hereinabove, it should be understood that many variations and/or modifications of the basic inventive concepts herein taught, which may appear to those skilled in the art, will still fall within the spirit and scope of the present invention.

What is claimed is:

1. A method of article storage and retrieval comprising:
determining if an article requested in a retrieval request is destined for storage; and
retrieving the article prior to storage when the determining step determines that the article requested in a retrieval request is destined for storage.

2. The method of claim 1 wherein the determining step comprises:
identifying articles being transported to storage; and wherein
the determining step determines if an article requested in a retrieval request is destined for storage based on output of the identifying step.

3. The method of claim 2, wherein the identifying step identifies a bar code marked on the articles.

4. The method of claim 1, wherein the determining step comprises:
identifying an article destined for storage;
accessing article information based on output of the identify step;
comparing the accessed article information with article information in the retrieval request; and
determining if an article requested in a retrieval request is destined for storage based on output of the comparing step.

5. The method of claim 4, wherein the accessed article information includes article identification information obtained in the identify step.

6. The method of claim 4, wherein the accessed article information includes article attribute information.

7. The method of claim 1, wherein the retrieving step comprises:
transferring the article from a storage path to a retrieval path.

8. A method of article storage and retrieval comprising:
determining if a retrieval request has been made for an article destined for storage; and
retrieving the article prior to storage when the determining step determines that a retrieval request has been made for the article destined for storage.

9. The method of claim 8 wherein the determining step comprises:
identifying articles being transported to storage; and wherein
the determining step determines if a retrieval request has been made for an article destined for storage based on output of the identifying step.

10. The method of claim 9, wherein the identifying step identifies a bar code marked on the articles.

11. The method of claim 8, wherein the determining step comprises:
identifying an article destined for storage;
accessing article information based on output of the identify step;
comparing the accessed article information with article information in the retrieval request; and
determining if a retrieval request has been made for an article destined for storage based on output of the comparing step

12. The method of claim 11, wherein the accessed article information includes article identification information obtained in the identify step.

13. The method of claim 11, wherein the accessed article information includes article attribute information.

14. The method of claim 8, further comprising:
storing the articles destined for storage if the determining step does not determine that a retrieval request has been made for the article destined for storage.

15. The method of claim 8, wherein the retrieving step comprises:
transferring the articles from a storage path to a retrieval path.

16. A method of article storage and retrieval comprising:
retrieving an article destined for storage based on identification of the article traveling to storage and a retrieval request.

17. A method of article storage and retrieval comprising:
storing an article destined for storage based on identification of the article traveling to storage and a storage request.

18. An article storage and retrieval arrangement comprising:
a storage conveyor configured to convey articles for storage;
an article identification unit configured to identify articles on the storage conveyor; and
a management server configured to manage storage and retrieval of articles destined for storage based on output of the article identification unit and received article retrieval requests.

19. The arrangement of claim 18, wherein the article identification unit is a bar code scanner.

20. The arrangement of claim 18, wherein the article identification unit is installed at one side of the storage conveyor.

21. The arrangement of claim 18, further comprising:
a retrieval conveyor configured to convey articles from storage;
a crane configured to transfer articles from the storage conveyor to at least the retrieval conveyor; and
wherein the management server controls operation of the crane.
